(19) United States
(12) Patent Application Publication
(10) Pub. No.: US 2008/0302394 A1
(43) Pub. Date: Dec. 11, 2008

(54) BRUSH AND METHODS OF CLEANING A BRUSH

(76) Inventors: Craig Robert Albrecht, St. Louis, MO (US); Jeffrey Graham Goldwasser, Clayton, MO (US); Mark Daryl Morrison, Stamford, CT (US)

Correspondence Address: ROBERT B. REESER, III;C/O ARMSTRONG TEASDALE LLP, ONE METROPOLITAN SQUARE, SUITE 2600, ST. LOUIS, MO, 63102, US

(21) Appl. No.: 11/758,383

(22) Filed: Jun. 5, 2007

(51) Int. Cl. B08B 1/02; A46D 1/00

(52) U.S. Cl. 134/32; 15/207.2

(57) ABSTRACT

A brush includes a body and a cleaning element. The body includes a plurality of bristles extending outward from said body. The cleaning element is slidably coupled to the body, and includes at least one projection and a retaining element. The at least one projection is substantially radially aligned with the plurality of bristles for engaging the plurality of bristles as the cleaning element is translated longitudinally across the body. The retaining element facilitates limiting circumferential movement of the plurality of bristles as the cleaning element is translated across the body.

### BACKGROUND OF THE INVENTION

This invention relates generally to brushes and more particularly, to brushes including a plurality of bristles and methods of cleaning such brushes.

A brush, such as a hair brush or a rotary brush used with a vacuum cleaner, tends to pick up foreign material, such as hair, debris, etc., with use. For example, with respect to hair brushes, hair products, such as gel or hair spray, tend to promote the transfer and fouling of foreign matter from the person's hair to the brush during subsequent uses. To prevent fouling of the brush, the bristles must be periodically cleaned, such as by dragging a second brush or comb through the bristles to loosen any foreign matter contained in the brush. Such a cleaning process may be time-consuming, inconvenient, and may be effective. Moreover, over time, the cleaning process may actually damage the bristles as the second brush or comb is drug across the brush. In addition, because of the design and weight of many known vacuum cleaners, removing foreign matter entrapped in the rotary brushes of such vacuums may be difficult.

To facilitate cleaning the bristles of a brush, at least some known brushes include a cleaning element. For example, U.S. Pat. No. 6,408,475, to Morrison, discloses a brush that includes a cleaning element that is slidably coupled to the brush. To facilitate cleaning the brush, the cleaning element is slid across that portion of the brush that includes the bristles and the foreign matter is pulled from the bristles by the cleaning element. Specifically, the cleaning element includes a plurality of slot elements that are spaced circumferentially about a plurality of circumferentially-spaced rows of bristles. As the cleaning element is slid over the bristles, the bristles are deflected by the cleaning element within the slot elements and the foreign matter is facilitated to be removed from the bristles. Although the brush disclosed in the '475 patent is effective at removing the foreign matter, the bristles may be circumferentially displaced by the cleaning element. Over time, as more of the bristles are displaced, the effectiveness of the brush may be decreased.

### BRIEF DESCRIPTION OF THE INVENTION

In one aspect, a brush is provided. The brush includes a body and a cleaning element. The body includes a plurality of bristles extending outward from said body. The cleaning element is slidably coupled to the body, and includes at least one projection and a retaining element. The at least one projection is substantially radially aligned with the plurality of bristles for engaging the plurality of bristles as the cleaning element is translated longitudinally across the body. The retaining element facilitates limiting circumferential movement of the plurality of bristles as the cleaning element is translated across the body.

In another aspect, a cleaning element for use with a brush that includes at least one row of bristles extending outward from a brush body is provided. The cleaning element includes a cylindrical body including a first side, a second side, and an opening extending therethrough. The cleaning element is configured to slidably couple to the brush such that the brush body extends through the opening. The cleaning element also includes at least one projection and a retaining element. The at least one projection is substantially radially aligned with the row of brush bristles for engaging the row of bristles as the cleaning element is translated longitudinally across the brush body. The retaining element facilitates limiting circumferential movement of the plurality of bristles as the cleaning element is translated across the brush body.

In a further aspect, a method for cleaning a brush is provided. The method includes determining that foreign matter is contained within a plurality of bristles extending outward from a body of the brush. The method also includes slidably translating a cleaning element including at least one projection and a retaining element at least partially longitundinally across the brush such that the at least one projection is substantially radially aligned with respect to the plurality of bristles and engages the plurality of bristles, and such that the retaining element facilitates limiting circumferential displacement of the plurality of bristles as the at least one projection is translated through the plurality of bristles, and then removing foreign matter against the cleaning element after the cleaning element has been translated at least partially across the plurality of bristles.

### BRIEF DESCRIPTION OF THE DRAWINGS

FIG. 1 is a perspective view of a portion of an exemplary brush including a cleaning element;

FIG. 2 is a cross-sectional view of the brush shown in FIG. 1 and taken along line 2-2;

FIG. 3 is an end view of the cleaning element shown in FIG. 1;

FIG. 4 is a perspective view of the brush shown in FIG. 1 during a cleaning process; and

FIG. 5 is a cross-sectional view of the brush and cleaning element shown in FIG. 4 and taken along line 5-5.

### DETAILED DESCRIPTION OF THE INVENTION

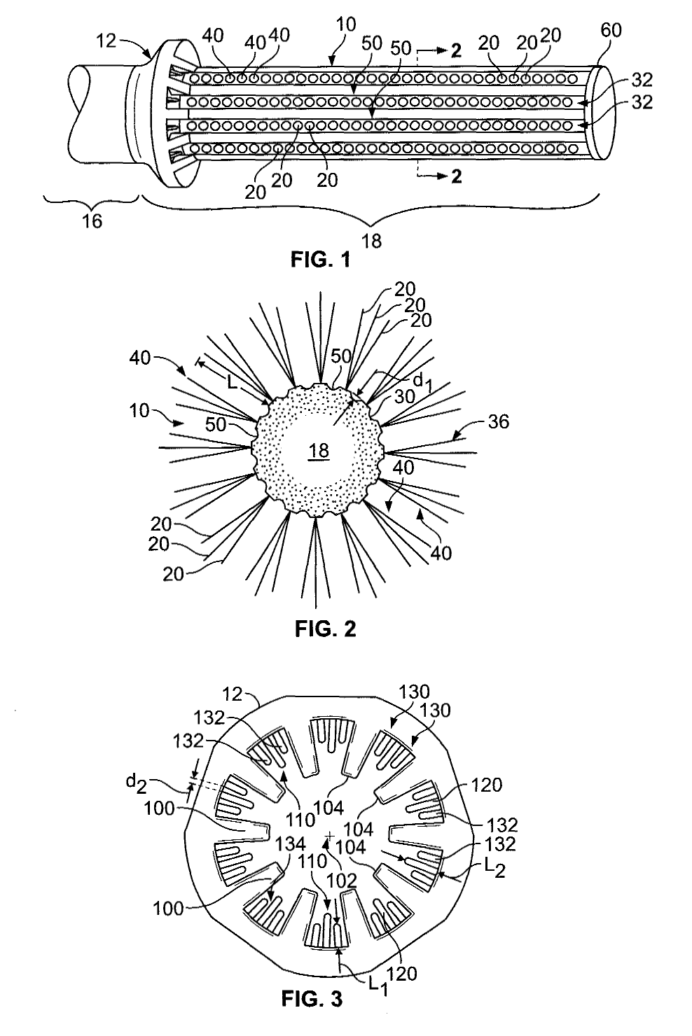

FIG. 1 is a perspective view of a portion of an exemplary brush 10 including a cleaning element 12. FIG. 2 is a cross-sectional view of brush 10 taken along line 2-2. In the exemplary embodiment, brush 10 includes a body 14 including a handle portion 16 and a bristle portion 18. More specifically, in the exemplary embodiment, body 14 is formed integrally with handle and bristle portions 16 and 18, respectively. In an alternative embodiment, brush 10 is a rotary brush that is used with a vacuum cleaner, for example, and as such, only includes bristle portion 18. Alternatively, brush 10 may be any brush that includes a plurality of bristles 20 that foreign matter, such as, but not limited to, hair, may undesirably become lodged therein.

Handle portion 16 extends from bristle portion 18, and as is known in the art, enables a user brushing hair, to grip brush 10. Bristle portion 18 includes a plurality of bristles 20. In the exemplary embodiment, bristle portion 18 has a generally circular cross-sectional profile defined by a contoured outer surface 30 of bristle portion 18. Alternatively, bristle portion 18 may have any cross-sectional profile that enables brush 10 and cleaning element 12 to function as described herein. For example, in an alternative embodiment, bristle portion 18 has a semi-circular cross-sectional profile.

In the exemplary embodiment, bristles 20 extend outward from outer surface 30. More specifically, in the exemplary embodiment, brush 10 includes a plurality of circumferentially-spaced rows 32 of bristles 20 that extend generally radially outward from body portion 18. Each row 32, in the exemplary embodiment, extends generally longitudinally across bristle portion 18 and each of the bristles 20 has a length L measured from outer surface 30 to a tip 36 spaced a distance radially outward from surface 30.

Bristles 20 each include a root portion (not shown) that facilitates coupling each bristle 20 to bristle portion 18. More specifically, in the exemplary embodiment, a plurality of bristles 20 are secured in clusters 40 to the same location, relative to bristle portion 18, and within each row 32 of bristles 20. As such, in the exemplary embodiment, each row of bristles 20 includes a plurality of longitudinally-spaced bristle clusters 40. Alternatively, bristles 20 may be secured to bristle portion 18 in any pattern, orientation, or arrangement that facilitates brush 10 and cleaning element 12 functioning as described herein.

In the exemplary embodiment, outer surface 30 is contoured and includes a plurality of grooves 50 defined therein. Moreover, in the exemplary embodiment, grooves 50 are circumferentially-spaced about outer surface 30. In an alternative embodiment, outer surface 30 is formed with only one groove 50. More specifically, in the exemplary embodiment, grooves 50 are spaced substantially equidistantly about portion 18 and are oriented such that each groove 50 is approximately circumferentially-centered between a pair of circumferentially-adjacent rows 32 of bristles 20. In alternative embodiments, brush 10 does not include grooves 30, but rather uses a different means of maintaining the relative alignment of cleaning element 12, as described herein.

Grooves 50 are formed with a depth d₁, a cross-sectional shape, a size, and an orientation that enables each groove to receive a portion of cleaning element 12 therein, as described in more detail below. Grooves 50, as described in more detail below, facilitate maintaining an alignment of cleaning element 12 with respect to body portion 18 and facilitate preventing cleaning element 12 from shifting, or becoming misaligned, circumferentially with respect to bristle portion 18.

In the exemplary embodiment, brush 10 also includes an end cap 60 coupled to bristle portion 18 such that bristle portion 18 extends longitudinally between end cap 18 and handle portion 16. End cap 60 facilitates providing structural support to bristle portion 18. In an alternative embodiment, end cap 60 facilitates preventing cleaning element 12 from uncoupling from brush 10. More specifically, in such an alternative embodiment, cleaning element 12 is slidably coupled to bristle portion 18, and end cap 60 prevents cleaning element 12 from sliding axially off of bristle portion 18.

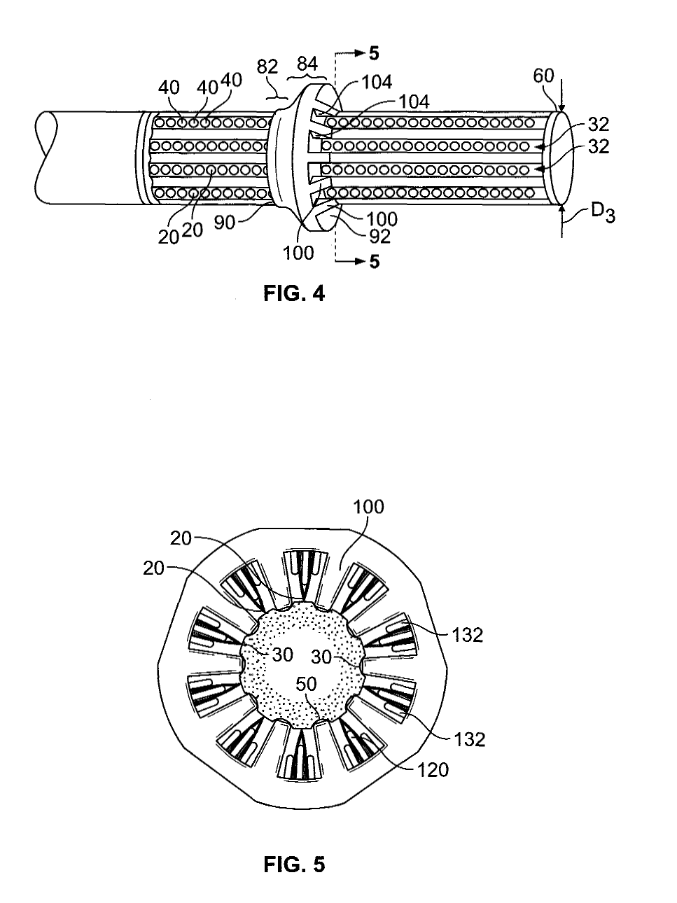

FIG. 3 is an end view of cleaning element 12. FIG. 4 is a perspective view of brush 10 during a cleaning process. FIG. 5 is a cross-sectional view of brush 10 and cleaning element 12 taken along line 5-5 (shown in FIG. 4). In the exemplary embodiment, cleaning element 12 includes a toroidal body 80 that includes a substantially cylindrical portion 82 and an integrally-formed frusto-conical portion 84 that extends substantially concentrically from cylindrical portion 82. More specifically, in the exemplary embodiment, each cylindrical portion 82 extends from an aft end 90 of element 12, to frusto-conical portion 84, and frusto-conical portion 84 extends from portion 82 to a forward end 92 of element 12. When cleaning element 12 is coupled to brush 10, cleaning element aft end 90 is between frusto-conical portion 84 and handle portion 16. Alternatively, cleaning element 12 may have any shape that enables cleaning element 12 and brush 10 to function as described herein.

In the exemplary embodiment, cylindrical portion 82 includes a plurality of circumferentially-spaced guide members 100 that extend generally radially inwardly towards a center 102 of portion 82 along forward end 92. More specifically, in the exemplary embodiment, each guide member 100 has a generally triangular cross-sectional shape and each is oriented such that a radially inner surface 104 of each guide member 100 extends generally longitudinally across, and substantially parallel to, brush outer surface 30 when element 12 is coupled to brush 10. In the exemplary embodiment, cleaning element 12 includes the same number, i.e., ten, of guide members 100 as grooves 50 formed in outer surface 30. Alternatively, cleaning element 12 may include any number of guide members 100 that is less than the number of grooves 50 defined in surface 30.

Each guide member 100 extends radially inwardly a distance that enables each member 100 to be substantially co-linearly aligned with, and slidably received within, a respective groove 50 when cleaning element 12 is slidably coupled around bristle portion 18. More specifically, the radial inner surface 104 of each guide member 100 is formed with a size, shape, and width, and is oriented at a depth that facilitates each guide member 100 being received in slidable contact within each groove 50. Members 100, as described in more detail below, cooperate with grooves 50 to facilitate maintaining an alignment of cleaning element 12 with respect to body portion 18 and to facilitate preventing cleaning element 12 from shifting, or becoming misaligned, circumferentially with respect to bristle portion 18. In an alternative embodiment, cleaning element 12 does not include members 100, but rather includes another component or means that facilitates maintaining the relative alignment of cleaning element 12, as described herein.

A plurality of channels 110 are spaced circumferentially about portion 82. More specifically, in the exemplary embodiment, each channel 110 is defined between a pair of circumferentially-adjacent guide members 100. Each channel 110 is sized and oriented radially outwardly from each row 32 of bristles 20 when cleaning element 12 is coupled to brush 10. As such, and as described in more detail below, each channel 110 is sized, shaped, and oriented to receive at least a portion of bristles 20 therein when cleaning element 12 is translated across bristle portion 18.

In the exemplary embodiment, a plurality of cleaning projections 120 extend generally radially inwardly towards element center 102, and are spaced circumferentially about element 12. More specifically, in the exemplary embodiment, one projection 120 is substantially centered within each channel 110 between each pair of circumferentially-adjacent members 100. In addition, in the exemplary embodiment, a plurality of retaining elements 130 that are spaced circumferentially about element 12. Specifically, in the exemplary embodiment, each retaining element 130 is positioned within a respective channel 110. More specifically, in the exemplary embodiment, each retaining element 130 includes a pair of circumferentially-spaced pins 132. Alternatively, cleaning element 12 may include any number of pins 132.

In the exemplary embodiment, pins 132 are identical and each is spaced a distance d₂ from each cleaning projection 120 and between each projection 120 and each respective member 100. As such, a gap 134 is defined between each projection 120 and each pin member 132. Gaps 134, as described in more detail below, facilitate the removal of debris and foreign matter from brush 10.

Pins 132, in the exemplary embodiment, are each formed with a length L₁ that is shorter than a length L₂ of each cleaning projection 120. Moreover, in the exemplary embodiment, the cleaning projection length L₂ enables each cleaning projection 120, as described in more detail below, to extend at least partially through each cluster 40 of bristles 20, to facilitate removing foreign matter lodged or entrapped in each cluster 40. More specifically, in the exemplary embodiment, the length L₂ of each projection 120 is longer than half of the height H₂ of each guide pin, i.e., L₂>½H₂. Alternatively, projection length L₂ may be any length that enables projections 120 and cleaning element 12 to function as described herein.

Gaps 134 are sized, as described in more detail below, to receive a portion of bristles 20 therethrough, as cleaning element 12 is slid across bristle portion 18. More specifically, gaps 134 are sized to facilitate limiting circumferential displacement of bristles 20 as cleaning element 12, and more specifically, cleaning projection 120 is forced through bristles 20 as cleaning element 12 is moved longitudinally across bristle portion 18.

During use of brush 10, cleaning element 12 remains in a stored position (as shown in FIG. 1) with respect to bristle portion 18. When foreign matter, such as, but not limited to, hair or lint, is lodged in brush bristles 20, and/or when brush 10 is desired to be cleaned, cleaning element 12 is slid across bristle portion 18 towards cap 60 (as shown in FIG. 4). More specifically, as brush 10 is used, and as is known in the art, over time, hair and other debris may collect in bristles 20 and in the spaces defined between adjust clusters 40 and between adjacent rows 32. As cleaning element 12 is moved longitudinally along bristle portion 18, each cleaning projection 120 is forced through bristles 20 in each row 32. Specifically, as cleaning element 12 is moved across bristle portion 18, cleaning element 120 causes bristles to deflect as debris and/or foreign matter lodged in bristles 20 is facilitated to be removed. More specifically, initially when contacted by cleaning element 120, bristles deflect towards cap 60 and are then displaced circumferentially around cleaning element 120 and into gaps 134.

Pins 132 facilitate limiting the circumferential deflection of bristles 20. As a result, the risk of inadvertent damage caused by over-bending of bristles 20 during a cleaning process is facilitated to be reduced. Moreover, because the circumferential displacement of bristles 20 is limited, more of the foreign matter contained in bristles 20 is facilitated to be removed by cleaning element 12. Pins 132 also facilitate the removal of debris and foreign matter from brush 10.

The effectiveness of cleaning element 12 is further enhanced by guide members 100. More specifically, as cleaning element 100 is moved across bristle portion 18, guide members 100 remain in grooves 50, such that circumferential shifting, or rotation, of cleaning element 12 with respect to bristle portion 18, is prevented. Moreover, in the exemplary embodiment, any foreign matter or debris spanning the areas defined between circumferentially-adjacent rows 32 of bristles 20, i.e., the areas of outer surface 30 in which grooves 50 are defined, is facilitated to be removed from brush 10 by members 100 and pins 132. More specifically, the triangular shape of members 100 facilitates forcing foreign matter, including hair, outwardly away from outer surface 30 and bristles 20.

In an alternative embodiment, the travel of cleaning element 12 across brush 10 is limited by cap 60. Specifically, in the alternative embodiment, cap 60 has a diameter D₃ that is sized to prevent cleaning element 12 from undesirably sliding off of bristle portion 18. In the exemplary embodiment, cleaning element 12 is removably coupled to brush 10 and may be slid past cap 60 to enable hair, debris, and/or foreign matter removed from brush 10, to be easily removed from cleaning element forward end 92 and from brush 10. As a result, the cleaning element provides a user with a convenient and effective means of cleaning a brush 10, while reducing the risk of damaging the bristles 20 the brush 10.

Exemplary embodiments of brushes including bristles and cleaning elements are described in detail above. The cleaning element described herein is not limited for use with the brush described herein, but rather, the cleaning element can be utilized independently and separately from other brush components described herein. For example, in one embodiment, the cleaning element described herein may be coupled to a rotary brush used with a vacuum cleaner to enable such brushes to be quickly and efficiently cleaned. Moreover, the invention is not limited to the embodiments of the cleaning elements described above in detail. Rather, other variations of the cleaning elements may be utilized within the spirit and scope of the claims. For example, the cleaning element may be modified to enable it to couple to an existing brush in a retrofit process.

While the invention has been described in terms of various specific embodiments, those skilled in the art will recognize that the invention can be practiced with modification within the spirit and scope of the claims.

What is claimed is:

1. A brush comprising:
a body comprising a plurality of bristles extending outward from said body; and
a cleaning element slidably coupled to said body, said cleaning element comprising at least one projection and a retaining element, said at least one projection is substantially radially aligned with said plurality of bristles for engaging said plurality of bristles as said cleaning element is translated longitudinally across said body, said retaining element facilitates limiting circumferential movement of said plurality of bristles as said cleaning element is translated across said body.

2. A brush in accordance with claim 1 wherein said plurality of bristles are oriented in at least one row extending substantially longitudinally across at least a portion of said brush body, said cleaning element facilitates removing foreign matter from said plurality of bristles as said cleaning element is translated across said body.

3. A brush in accordance with claim 1 wherein said plurality of bristles are oriented in a plurality of circumferentially-spaced rows, each of said plurality of rows extends substantially longitudinally across at least a portion of said brush body, said cleaning element facilitates removing foreign matter from said plurality of rows of bristles as said cleaning element is translated across said body.

4. A brush in accordance with claim 1 wherein said plurality of bristles are oriented in a plurality of circumferentially-spaced rows, said brush body comprises a plurality of grooves defined therein, each of said plurality of grooves extends substantially longitudinally across at least a portion of said brush body.

5. A brush in accordance with claim 4 wherein each of said plurality of rows of bristles extends between an adjacent pair of said circumferentially-spaced grooves.

6. A brush in accordance with claim 4 wherein said cleaning element further comprises a plurality of circumferentially-spaced guide members, each of said plurality of guide members is slidably coupled within a respective one of said body grooves.

7. A brush in accordance with claim 4 wherein said plurality of grooves facilitate maintaining an alignment of said cleaning element with respect to said brush body.

8. A brush in accordance with claim 1 wherein said retaining element further comprises a pair of circumferentially-spaced pin members, said at least one projection is substantially centered between said pair of pin members.

9. A brush in accordance with claim 9 wherein each of said pin members is spaced a distance from said at least one projection such that a gap is defined between said at least one projection and each of said pin members.

10. A brush in accordance with claim 10 wherein each of said gaps is sized to receive a portion of said plurality of bristles therein as said cleaning element is translated across said body.

11. A brush in accordance with claim 1 wherein said at least one projection has a length that enables said at least one projection to extend a distance at least partially through said plurality of bristles as said cleaning element is translated across said body.

12. A cleaning element for use with a brush that includes at least one row of bristles extending outward from a brush body, said cleaning element comprises a cylindrical body comprising a first side, a second side, and an opening extending therethrough, said cleaning element is configured to slidably couple to the brush such that said brush extends through said opening, said cleaning element further comprises at least one projection and a retaining element, said at least one projection is substantially radially aligned with the row of brush bristles for engaging the row of bristles as said cleaning element is translated longitudinally across the brush body, said retaining element facilitates limiting circumferential movement of the plurality of bristles as said cleaning element is translated across the brush body.

13. A cleaning element in accordance with claim 12 wherein said at least one projection facilitates removing foreign matter from the brush as said cleaning element is translated across the brush body.

14. A cleaning element in accordance with claim 12 further comprising a plurality of circumferentially-spaced guide members configured to facilitate maintaining an alignment of said cleaning element with respect to the brush.

15. A cleaning element in accordance with claim 12 wherein said retaining element comprises a pair of circumferentially-spaced pin members, said at least one projection is substantially centered between said pair of pin members such that a gap is defined between said at least one projection and each of said pin members.

16. A cleaning element in accordance with claim 15 wherein said each of said pin members is identical, a length of said at least one projection is longer than a length of each of said pair of pin members.

17. A cleaning element in accordance with claim 12 wherein said body is formed integrally with said at least one projection and said retaining element.

18. A brush comprising:
a body comprising an outer surface and a plurality of bristles extending outward from said outer surface;
a cleaning element slidably coupled to said body, said cleaning element comprises at least one projection and at least one retaining element, said at least one projection is substantially radially aligned with said plurality of bristles for engaging said plurality of bristles as said cleaning element is translated longitudinally across said body, said retaining element facilitates limiting circumferential displacement of said plurality of bristles as said cleaning element is translated across said body, said outer surface facilitates circumferentially aligning said cleaning element with respect to said body.

19. A brush in accordance with claim 18 wherein said plurality of bristles are oriented in at least one row extending substantially longitudinally across at least a portion of said brush body, said cleaning element facilitates removing foreign matter from said plurality of bristles as said cleaning element is translated across said body.

20. A brush in accordance with claim 18 wherein said brush body comprises a plurality of grooves defined therein, each of said plurality of grooves extends substantially longitudinally across at least a portion of said brush body.

21. A brush in accordance with claim 20 wherein each of said plurality of rows of bristles extends between an adjacent pair of said circumferentially-spaced grooves.

22. A brush in accordance with claim 20 wherein said plurality of grooves facilitate maintaining an alignment of said cleaning element with respect to said brush body.

23. A brush in accordance with claim 20 wherein said cleaning element further comprises at least one guide-member slidably coupled within one of said plurality of body groove.

24. A brush in accordance with claim 23 wherein said at least one projection and at least one retaining element are between a pair of circumferentially-adjacent guide members.

25. A brush in accordance with claim 18 wherein said plurality of bristles are oriented in a plurality of circumferentially-spaced rows, each of said plurality of rows extends substantially longitudinally across at least a portion of said brush body, said cleaning element facilitates removing debris from said plurality of rows of bristles.

26. A brush in accordance with claim 18 wherein said retaining element further comprises a pair of circumferentially-spaced pin members, said cleaning element at least one projection is substantially centered between said pair of pin members.

27. A brush in accordance with claim 26 wherein each of said pin members is spaced a distance from said at least one projection such that a gap is defined between said at least one projection and each of said pin members.

28. A brush in accordance with claim 26 wherein said at least one projection has a length that is longer than a length of each of said pin members.

29. A method for cleaning a brush, said method comprises:
determining that foreign matter is contained within a plurality of bristles extending outward from a body of the brush;
slidably translating a cleaning element including at least one projection and a retaining element at least partially longitudinally across the brush such that the at least one projection is substantially radially aligned with respect to the plurality of bristles and engages the plurality of bristles, and such that the retaining element facilitates limiting circumferential displacement of the plurality of bristles as the at least one projection is translated through the plurality of bristles; and
removing foreign matter against the cleaning element after the cleaning element has been translated at least partially across the plurality of bristles.

30. A method in accordance with claim 29 wherein slidably translating a cleaning element further comprises slidably translating the cleaning element across the brush body such that a portion of the cleaning element remains within a groove defined on the brush body that facilitates maintaining an alignment of the cleaning element with respect to the brush body.

31. A method in accordance with claim 29 wherein slidably translating a cleaning element further comprises slidably translating the cleaning element over a plurality of circumferentially-spaced rows of bristles that extend generally longitudinally across a portion of the brush body.

32. A method in accordance with claim 29 wherein slidably translating a cleaning element further comprises slidably translating the cleaning element over the plurality of bristles such that the at least one projection extends a distance into the plurality of bristles to facilitate removing foreign matter from said plurality of bristles.

33. A method in accordance with claim 29 wherein the retaining element includes a pair of circumferentially-spaced pin members, said method further comprises slidably translating the cleaning element over the plurality of bristles such that the at least one projection extends a distance into the plurality of bristles to facilitate removing foreign matter from said plurality of bristles, and such that the pin members facilitate limiting circumferential displacement of the plurality of bristles.
